(19) United States
(12) Patent Application Publication
(10) Pub. No.: US 2025/0185077 A1
(43) Pub. Date: Jun. 5, 2025

(54) METHODS AND APPARATUSES OF A 2-STEP RACH PROCEDURE FOR REDCAP UES AND NON-REDCAP UES

(71) Applicant: Lenovo (Beijing) Limited, Beijing (CN)

(72) Inventors: Yuantao Zhang, Beijing (CN); Hongmei Liu, Beijing (CN); Zhi Yan, Beijing (CN); Yingying Li, Beijing (CN); Haiming Wang, Beijing (CN)

(73) Assignee: Lenovo (Beijing) Limited, Beijing (CN)

(21) Appl. No.: 18/843,568

(22) PCT Filed: Mar. 4, 2022
(86) PCT No.: PCT/CN2022/079278

§ 371 Date: Sep. 3, 2024

(51) Int. Cl. H04W 74/0836; H04W 72/21

(52) U.S. Cl. CPC H04W 74/0836; H04W 72/21

(57) ABSTRACT

Embodiments of the present application relate to methods and apparatuses of a 2-step random access channel (RACH) procedure for reduced capability (RedCap) user equipments (UEs) and non-RedCap UEs. According to an embodiment of the present application, a user equipment (UE) includes a processor and a transceiver coupled to the processor; and the processor is configured: to receive physical random access channel (PRACH) configurations via the transceiver; to determine a PRACH resource based on the PRACH configurations; and to determine a set of PUSCH resources for the UE based on at least one of: an association of the PRACH resource with a further PRACH resource within a set of PRACH resources, or an association of the PRACH resource with a set of further PUSCH resources.

### TECHNICAL FIELD

Embodiments of the present application generally relate to wireless communication technology, in particular to methods and apparatuses of a 2-step random access channel (RACH) procedure for reduced capability (RedCap) user equipments (UEs) and non-RedCap UEs.

### BACKGROUND

In 3GPP (3rd Generation Partnership Project), in addition to legacy UEs, various new types of UEs have emerged, such as industrial wireless sensors, video surveillances, wearables, and etc. Different from the legacy UEs (e.g., enhanced mobile broadband (eMBB) and ultra-reliable low latency communication (URLLC) UEs), these new types of UEs may have the features including, e.g., reduced number of receive or transmit antennas, UE bandwidth reduction, half frequency-division duplex, relaxed UE processing time, relaxed UE processing capability, or etc. These new types of UEs can be referred to as reduced capability (RedCap) UEs.

The RedCap UEs may be identified by a base station (BS), such that the BS may perform access control and/or scheduling control, e.g., during a random access (RA) procedure. Details regarding resource determination for the physical uplink shared channel (PUSCH) for a 2-step RACH procedure for RedCap UEs shall be solved when the PUSCH resource is shared with non-RedCap UEs.

### SUMMARY

Some embodiments of the present application also provide a first type of user equipment (UE). The first type of UE includes a processor and a transceiver coupled to the processor; and the processor of the first type of UE is configured: to receive physical random access channel (PRACH) configurations via the transceiver; to determine a first PRACH resource based on the PRACH configurations; and to determine a set of first PUSCH resources for the first type of UE based on at least one of: an association of the first PRACH resource with a second PRACH resource within a set of PRACH resources, or an association of the first PRACH resource with a set of second PUSCH resources.

In some embodiments, at least one of the set of PRACH resources or the set of second PUSCH resources is configured for one or more second type of UEs.

In some embodiments, the first type of UE is a reduced capability (RedCap) UE, and the one or more second type of UEs are non-RedCap UEs.

In some embodiments, the first PRACH resource is a subset of the set of PRACH resources.

In some embodiments, the first PRACH resource is associated with the second PRACH resource, and the first PRACH resource and the second PRACH resource have a same index value in a time domain.

In some embodiments, the first PRACH resource is associated with the second PRACH resource, and the second PRACH resource is a time domain firstly appeared PRACH resource within the set of PRACH resources which is subsequent to the first PRACH resource.

In some embodiments, the first PRACH resource and the second PRACH resource are adjacent in the time domain.

In some embodiments, at least one of the first PRACH resource or the second PRACH resource includes one PRACH slot.

In some embodiments, preambles transmitted in random access channel occasions (ROs) in the first PRACH resource are mapped to PUSCH resource units (PRUs) within the set of first PUSCH resources.

In some embodiments, at least one resource of the first PRACH resource, the set of PRACH resources, the set of first PUSCH resources, or the set of second PUSCH resources is a resource associated with at least one of: a time domain, a frequency domain, or a spatial domain.

In some embodiments, the set of first PUSCH resources is the set of second PUSCH resources; or the set of first PUSCH resources is a subset of the set of second PUSCH resources.

In some embodiments, a total number of resources included in the subset of the set of second PUSCH resources is configured by a network node.

In some embodiments, in response to the set of first PUSCH resources being the set of second PUSCH resources, the set of second PUSCH resources is a time domain firstly appeared set of PUSCH resources which is subsequent to the first PRACH resource.

In some embodiments, in response to the set of first PUSCH resources being the set of second PUSCH resources, the set of second PUSCH resources is a time domain firstly appeared set of PUSCH resources which is subsequent to the first PRACH resource after a time gap.

In some embodiments, a starting time instance of the time gap is identical with or later than an ending time instance of the set of first PUSCH resources.

In some embodiments, the time gap is: a time offset configured by a network node for the one or more second type of UEs, wherein the time offset is between a starting time instance of a PRACH resource of the set of PRACH resources and a starting time instance of a time domain firstly appeared PUSCH resource within the set of second PUSCH resources, wherein the time domain firstly appeared PUSCH resource is associated with the PRACH resource; or a time duration configured by the network node, wherein the time duration starts from a starting time instance or an ending time instance of the first PRACH resource.

In some embodiments, the processor of the first type of UE is configured: to order preambles transmitted in ROs in the first PRACH resource; to order PRUs of PUSCH occasions (POs) in the set of first PUSCH resources; and to map the ordered preambles transmitted in the ROs in the first PRACH resource to the ordered PRUs of the POs in the set of first PUSCH resources.

In some embodiments, to map the ordered preambles transmitted in the ROs to the ordered PRUs of the POs, the processor of the first type of UE is configured: to map a preamble with a minimum index value within the ordered preambles transmitted in the ROs to a PRU with a minimum index value within the ordered PRUs of the POs; or to map the preamble with the minimum index value within the ordered preambles transmitted in the ROs to a PRU with a configured index value or a pre-configured index value within the ordered PRUs of the POs; or to map a preamble with a maximum index value within the ordered preambles transmitted in the ROs to a PRU with a maximum index value within the ordered PRUs of the POs; or to map the ordered preambles transmitted in the ROs to a subset of the ordered PRUs of the POs based on a configuration.

Some embodiments of the present application provide a method, which may be performed by a first type of UE. The method includes: receiving physical random access channel (PRACH) configurations; determining a first PRACH resource based on the PRACH configurations; and determining a set of first PUSCH resources for the first type of UE based on at least one of: an association of the first PRACH resource with a second PRACH resource within a set of PRACH resources, or an association of the first PRACH resource with a set of second PUSCH resources.

In some embodiments, at least one of the set of PRACH resources or the set of second PUSCH resources is configured for one or more second type of UEs.

In some embodiments, the first type of UE is a reduced capability (RedCap) UE, and the one or more second type of UEs are non-RedCap UEs.

In some embodiments, the first PRACH resource is a subset of the set of PRACH resources.

In some embodiments, the first PRACH resource is associated with the second PRACH resource, and the first PRACH resource and the second PRACH resource have a same index value in a time domain.

In some embodiments, the first PRACH resource is associated with the second PRACH resource, and the second PRACH resource is a time domain firstly appeared PRACH resource within the set of PRACH resources which is subsequent to the first PRACH resource.

In some embodiments, the first PRACH resource and the second PRACH resource are adjacent in the time domain.

In some embodiments, at least one of the first PRACH resource or the second PRACH resource includes one PRACH slot.

In some embodiments, preambles transmitted in random access channel occasions (ROs) in the first PRACH resource are mapped to PUSCH resource units (PRUs) within the set of first PUSCH resources.

In some embodiments, at least one resource of the first PRACH resource, the set of PRACH resources, the set of first PUSCH resources, or the set of second PUSCH resources is a resource associated with at least one of: a time domain, a frequency domain, or a spatial domain.

In some embodiments, the set of first PUSCH resources is the set of second PUSCH resources; or the set of first PUSCH resources is a subset of the set of second PUSCH resources.

In some embodiments, a total number of resources included in the subset of the set of second PUSCH resources is configured by a network node.

In some embodiments, in response to the set of first PUSCH resources being the set of second PUSCH resources, the set of second PUSCH resources is a time domain firstly appeared set of PUSCH resources which is subsequent to the first PRACH resource.

In some embodiments, in response to the set of first PUSCH resources being the set of second PUSCH resources, the set of second PUSCH resources is a time domain firstly appeared set of PUSCH resources which is subsequent to the first PRACH resource after a time gap.

In some embodiments, a starting time instance of the time gap is identical with or later than an ending time instance of the set of first PUSCH resources.

In some embodiments, the time gap is: a time offset configured by a network node for the one or more second type of UEs, wherein the time offset is between a starting time instance of a PRACH resource of the set of PRACH resources and a starting time instance of a time domain firstly appeared PUSCH resource within the set of second PUSCH resources, wherein the time domain firstly appeared PUSCH resource is associated with the PRACH resource; or a time duration configured by a network node, wherein the time duration starts from a starting time instance or an ending time instance of the first PRACH resource.

In some embodiments, the method further comprises: ordering preambles transmitted in ROs in the first PRACH resource; to order PRUs of PUSCH occasions (POs) in the set of first PUSCH resources; and mapping the ordered preambles transmitted in the ROs in the first PRACH resource to the ordered PRUs of the POs in the set of first PUSCH resources.

In some embodiments, mapping the ordered preambles transmitted in the ROs to the ordered PRUs of the POs further comprises: mapping a preamble with a minimum index value within the ordered preambles transmitted in the ROs to a PRU with a minimum index value within the ordered PRUs of the POs; or mapping the preamble with the minimum index value within the ordered preambles transmitted in the ROs to a PRU with a configured index value or a pre-configured index value within the ordered PRUs of the POs; or mapping a preamble with a maximum index value within the ordered preambles transmitted in the ROs to a PRU with a maximum index value within the ordered PRUs of the POs; or mapping the ordered preambles transmitted in the ROs to a subset of the ordered PRUs of the POs based on a configuration.

Some embodiments of the present application also provide an apparatus for wireless communications. The apparatus includes: a non-transitory computer-readable medium having stored thereon computer-executable instructions; a receiving circuitry; a transmitting circuitry; and a processor coupled to the non-transitory computer-readable medium, the receiving circuitry and the transmitting circuitry, wherein the computer-executable instructions cause the processor to implement any of the above-mentioned methods performed by a UE.

Some embodiments of the present application also provide a network node (e.g., a base station (BS)). The network node includes a processor and a transceiver coupled to the processor; and the processor of the network node is configured: to transmit physical random access channel (PRACH) configurations for one or more first type of user equipments (UEs) via the transceiver; to receive a preamble on a first PRACH resource for one UE within the one or more of first type of UEs via the transceiver; and to determine a set of first PUSCH resources for the one UE based on at least one of: an association of the first PRACH resource with a second PRACH resource within a set of PRACH resources, or an association of the first PRACH resource with a set of second PUSCH resources.

In some embodiments, at least one of the set of PRACH resources or the set of second PUSCH resources is configured for one or more second type of UEs.

In some embodiments, the one UE is a reduced capability (RedCap) UE, and the one or more second type of UEs are a non-RedCap UE.

In some embodiments, the first PRACH resource is a subset of the set of PRACH resources.

In some embodiments, the first PRACH resource is associated with the second PRACH resource, and the first PRACH resource and the second PRACH resource have a same index value in a time domain.

In some embodiments, the first PRACH resource is associated with the second PRACH resource, and the second PRACH resource is a time domain firstly appeared PRACH resource within the set of PRACH resources which is subsequent to the first PRACH resource.

In some embodiments, the first PRACH resource and the second PRACH resource are adjacent in the time domain.

In some embodiments, at least one of the first PRACH resource or the second PRACH resource includes one PRACH slot.

In some embodiments, preambles transmitted in random access channel occasions (ROs) in the first PRACH resource are mapped to PUSCH resource units (PRUs) within the set of first PUSCH resources.

In some embodiments, at least one resource of the first PRACH resource, the set of PRACH resources, the set of first PUSCH resources, or the set of second PUSCH resources is a resource associated with at least one of: a time domain, a frequency domain, or a spatial domain.

In some embodiments, the set of first PUSCH resources is the set of second PUSCH resources; or the set of first PUSCH resources is a subset of the set of second PUSCH resources.

In some embodiments, a total number of resources included in the subset of the set of second PUSCH resources is configured by the network node.

In some embodiments, in response to the set of first PUSCH resources being the set of second PUSCH resources, the set of second PUSCH resources is a time domain firstly appeared set of PUSCH resources which is subsequent to the first PRACH resource.

In some embodiments, in response to the set of first PUSCH resources being the set of second PUSCH resources, the set of second PUSCH resources is a time domain firstly appeared set of PUSCH resources which is subsequent to the first PRACH resource after a time gap.

In some embodiments, a starting time instance of the time gap is identical with or later than an ending time instance of the set of first PUSCH resources.

In some embodiments, the time gap is: a time offset configured by the network node for the one or more second type of UEs, wherein the time offset is between a starting time instance of a PRACH resource of the set of PRACH resources and a starting time instance of a time domain firstly appeared PUSCH resource within the set of second PUSCH resources, wherein the time domain firstly appeared PUSCH resource is associated with the PRACH resource; or a time duration configured by the network node, wherein the time duration starts from a starting time instance or an ending time instance of the first PRACH resource.

In some embodiments, the processor of the network node is configured: to order preambles transmitted in ROs in the first PRACH resource; to order PRUs of PUSCH occasions (POs) in the set of first PUSCH resources; and to map the ordered preambles transmitted in the ROs in the first PRACH resource to the ordered PRUs of the POs in the set of first PUSCH resources.

In some embodiments, to map the ordered preambles transmitted in the ROs to the ordered PRUs of the POs, the processor of the network node is configured: to map a preamble with a minimum index value within the ordered preambles transmitted in the ROs to a PRU with a minimum index value within the ordered PRUs of the POs; or to map the preamble with the minimum index value within the ordered preambles transmitted in the ROs to a PRU with a configured index value or a pre-configured index value within the ordered PRUs of the POs; or to map a preamble with a maximum index value within the ordered preambles transmitted in the ROs to a PRU with a maximum index value within the ordered PRUs of the POs; or to map the ordered preambles transmitted in the ROs to a subset of the ordered PRUs of the POs based on a configuration.

Some embodiments of the present application provide a method, which may be performed by a network node (e.g., a BS). The method includes: transmitting physical random access channel (PRACH) configurations for one or more first type of user equipments (UEs); receiving a preamble on a first PRACH resource for one UE within the one or more of first type of UEs; and determining a set of first PUSCH resources for the one UE based on at least one of: an association of the first PRACH resource with a second PRACH resource within a set of PRACH resources, or an association of the first PRACH resource with a set of second PUSCH resources.

In some embodiments, at least one of the set of PRACH resources or the set of second PUSCH resources is configured for a second type of UE.

In some embodiments, the one UE is a reduced capability (RedCap) UE, and the second type of UE is a non-RedCap UE.

In some embodiments, the first PRACH resource is a subset of the set of PRACH resources.

In some embodiments, the first PRACH resource is associated with the second PRACH resource, and the first PRACH resource and the second PRACH resource have a same index value in a time domain.

In some embodiments, the first PRACH resource is associated with the second PRACH resource, and the second PRACH resource is a time domain firstly appeared PRACH resource within the set of PRACH resources which is subsequent to the first PRACH resource.

In some embodiments, the first PRACH resource and the second PRACH resource are adjacent in the time domain.

In some embodiments, at least one of the first PRACH resource or the second PRACH resource includes one PRACH slot.

In some embodiments, preambles transmitted in random access channel occasions (ROs) in the first PRACH resource are mapped to PUSCH resource units (PRUs) within the set of first PUSCH resources.

In some embodiments, at least one resource of the first PRACH resource, the set of PRACH resources, the set of first PUSCH resources, or the set of second PUSCH resources is a resource associated with at least one of: a time domain, a frequency domain, or a spatial domain.

In some embodiments, the set of first PUSCH resources is the set of second PUSCH resources; or the set of first PUSCH resources is a subset of the set of second PUSCH resources.

In some embodiments, a total number of resources included in the subset of the set of second PUSCH resources is configured by the network node.

In some embodiments, in response to the set of first PUSCH resources being the set of second PUSCH resources, the set of second PUSCH resources is a time domain firstly appeared set of PUSCH resources which is subsequent to the first PRACH resource.

In some embodiments, in response to the set of first PUSCH resources being the set of second PUSCH resources, the set of second PUSCH resources is a time domain firstly appeared set of PUSCH resources which is subsequent to the first PRACH resource after a time gap.

In some embodiments, a starting time instance of the time gap is identical with or later than an ending time instance of the set of first PUSCH resources.

In some embodiments, the time gap is: a time offset configured by the network node for the one or more second type of UEs, wherein the time offset is between a starting time instance of a PRACH resource of the set of PRACH resources and a starting time instance of a time domain firstly appeared PUSCH resource within the set of second PUSCH resources, wherein the time domain firstly appeared PUSCH resource is associated with the PRACH resource; or a time duration configured by the network node, wherein the time duration starts from a starting time instance or an ending time instance of the first PRACH resource.

In some embodiments, the method further comprises: ordering preambles transmitted in ROs in the first PRACH resource; to order PRUs of PUSCH occasions (POs) in the set of first PUSCH resources; and mapping the ordered preambles transmitted in the ROs in the first PRACH resource to the ordered PRUs of the POs in the set of first PUSCH resources.

In some embodiments, mapping the ordered preambles transmitted in the ROs to the ordered PRUs of the POs further comprises: mapping a preamble with a minimum index value within the ordered preambles transmitted in the ROs to a PRU with a minimum index value within the ordered PRUs of the POs; or mapping the preamble with the minimum index value within the ordered preambles transmitted in the ROs to a PRU with a configured index value or a pre-configured index value within the ordered PRUs of the POs; or mapping a preamble with a maximum index value within the ordered preambles transmitted in the ROs to a PRU with a maximum index value within the ordered PRUs of the POs; or mapping the ordered preambles transmitted in the ROs to a subset of the ordered PRUs of the POs based on a configuration.

Some embodiments of the present application provide an apparatus. The apparatus includes: a non-transitory computer-readable medium having stored thereon computer-executable instructions, a receiving circuitry; a transmitting circuitry; and a processor coupled to the non-transitory computer-readable medium, the receiving circuitry and the transmitting circuitry, wherein the computer-executable instructions cause the processor to implement any of the above-mentioned methods performed by a network node (e.g., a BS).

The details of one or more examples are set forth in the accompanying drawings and the descriptions below. Other features, objects, and advantages will be apparent from the descriptions and drawings, and from the claims.

### BRIEF DESCRIPTION OF THE DRAWINGS

Some example embodiments will now be described, by way of non-limiting examples, with reference to the accompanying drawings.

FIG. 1 illustrates an exemplary flow chart of a 2-step RACH procedure.

FIG. 2 illustrates an exemplary diagram of mapping preambles to PRUs in accordance with some embodiments of the present disclosure.

FIG. 3 illustrates an exemplary flowchart of determining a set of PUSCH resources in accordance with some embodiments of the present application.

FIG. 4 illustrates a further exemplary flowchart of determining a set of PUSCH resources in accordance with some embodiments of the present application.

FIG. 5 illustrates an exemplary diagram of mapping preambles to PRUs for RedCap UEs in accordance with some embodiments of the present disclosure.

FIGS. 6A and 6B illustrate further exemplary diagrams of mapping preambles to PRUs for RedCap UEs in accordance with some embodiments of the present disclosure.

FIGS. 7A and 7B illustrate additional exemplary diagrams of mapping preambles to PRUs for RedCap UEs in accordance with some embodiments of the present disclosure.

FIGS. 8A-8D illustrate exemplary diagrams of mapping preambles to PRUs for RedCap and non-RedCap UEs in accordance with some embodiments of the present disclosure.

FIG. 9 illustrates an exemplary diagram of mapping preambles to PRUs for RedCap and non-RedCap UEs in accordance with some embodiments of the present disclosure.

FIG. 10 illustrates an exemplary block diagram of an apparatus for mapping preambles to PRUs for a RedCap UE in accordance with some embodiments of the present application.

FIG. 11 illustrates a further exemplary block diagram of an apparatus for mapping preambles to PRUs for a RedCap UE in accordance with some embodiments of the present application.

### DETAILED DESCRIPTION

The detailed description of the appended drawings is intended as a description of the preferred embodiments of the present invention, and is not intended to represent the only form in which the present invention may be practiced. It should be understood that the same or equivalent functions may be accomplished by different embodiments that are intended to be encompassed within the spirit and scope of the present invention.

Reference will now be made in detail to some embodiments of the present application, examples of which are illustrated in the accompanying drawings. To facilitate understanding, embodiments are provided under specific network architecture and new service scenarios, such as 3rd Generation Partnership Project (3GPP) LTE and LTE advanced, 3GPP 5G NR, 5G-Advanced, 6G, and so on. It is contemplated that along with developments of network architectures and new service scenarios, all embodiments in the present application are also applicable to similar technical problems; and moreover, the terminologies recited in the present application may change, which should not affect the principle of the present application.

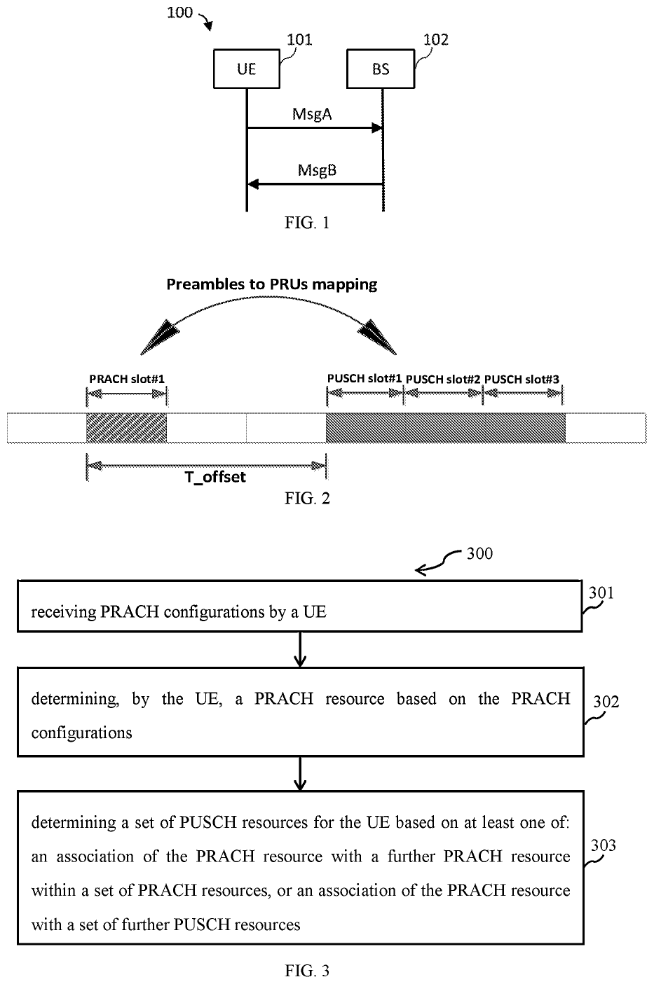

FIG. 1 illustrates an exemplary flow chart of a 2-step RACH procedure. As shown in FIG. 1A, the wireless communication system 100 includes UE 101 and BS 102.

UE 101 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to an embodiment of the present disclosure, UE 101 may include a portable wireless communication device, a smart phone, a cellular telephone, a flip phone, a device having a subscriber identity module, a personal computer, a selective call receiver, a sensor, a video surveillance device, a wearable device, or any other device that is capable of sending and receiving communication signals on a wireless network. In some embodiments, UE 101 includes wearable devices, such as smart watches, fitness bands, optical head-mounted displays, or the like. Moreover, UE 101 may be referred to as a subscriber unit, a mobile, a mobile station, a user, a terminal, a mobile terminal, a wireless terminal, a fixed terminal, a subscriber station, a user terminal, or a device, or described using other terminology used in the art. UE 101 may communicate directly with BS 102 via uplink (UL) communication signals. In some examples, UE 101 in FIG. 1 may function as a RedCap UE.

BS 102 may be distributed over a geographic region. In certain embodiments, each of BS 102 may also be referred to as an access point, an access terminal, a base, a macro cell, a Node-B, an enhanced Node B (eNB), a gNB, a Home Node-B, a relay node, or a device, or described using other terminology used in the art. BS 102 are generally part of a radio access network that may include one or more controllers communicably coupled to one or more corresponding BS 102.

The wireless communication system 100 is compatible with any type of network that is capable of sending and receiving wireless communication signals. For example, the wireless communication system 100 is compatible with a wireless communication network, a cellular telephone network, a Time Division Multiple Access (TDMA)-based network, a Code Division Multiple Access (CDMA)-based network, an Orthogonal Frequency Division Multiple Access (OFDMA)-based network, an LTE network, a 3GPP-based network, a 3GPP 5G network, a satellite communications network, a high altitude platform network, and/or other communications networks.

In one embodiment, the wireless communication system 100 is compatible with the 5G new radio (NR) of the 3GPP protocol, wherein BS 102 transmit data using an orthogonal frequency division multiplexing (OFDM) modulation scheme on the downlink and UE 101 transmit data on the uplink using Discrete Fourier Transform-Spread-Orthogonal Frequency Division Multiplexing (DFT-S-OFDM) or Cyclic Prefix-Orthogonal Frequency Division Multiplexing (CP-OFDM) scheme. More generally, however, the wireless communication system 100 may implement some other open or proprietary communication protocols, for example, WiMAX, among other protocols.

In other embodiments, BS 102 may communicate using other communication protocols, such as the IEEE 802.11 family of wireless communication protocols. Further, in some embodiments, BS 102 may communicate over licensed spectrums, whereas in other embodiments BS 102 may communicate over unlicensed spectrums. The present disclosure is not intended to be limited to the implementation of any particular wireless communication system architecture or protocol. In another embodiment, BS 102 may communicate with UE 101 using the 3GPP 5G protocols.

Currently, a 2-step RACH procedure has been specified in 3GPP standard document and could be configured for a UE in a radio resource control (RRC) idle state, an RRC inactive state, or an RRC connected state. In NR 2-step RACH procedure, a MsgA is transmitted from a UE to a BS, and a MsgB is feedback from the BS as the response message for MsgA.

In the exemplary method 100 as shown FIG. 1, in a 2-step RACH procedure, UE 101 sends a MsgA to BS 102, and then, BS 102 sends a MsgB to UE 101. The MsgA has a preamble part and a data part. The preamble part is transmitted in a valid RACH occasion (RO) from a PRACH slot, and the data part (i.e., MsgA PUSCH) is transmitted in a PUSCH occasion (PO) in a PUSCH slot.

A PRACH slot might contain a set of RACH occasions, each of which occupies configured time and frequency domain resource(s) in the PRACH slot. A PUSCH slot might contain a set of POs, and each PO occupies configured time and frequency domain resource(s).

For non-RedCap UEs, a PRACH slot might be associated with a set of consecutive PUSCH slots (e.g., nrofSlotsMsgA-PUSCH as defined in 3GPPstandard document TS38.331). The association is based on a configured time offset (e.g., msgA-PUSCH-TimeDomainOffset as defined in 3GPPstandard document TS38.331) between the PRACH slot and the time domain firstly appeared PUSCH slot within the set of consecutive PUSCH slots.

For different UEs, besides separation in time and frequency domains, a MsgA PUSCH can also be separated in the spatial domain. This is enabled by using different demodulation reference signal (DMRS) ports and/or sequences for the MsgA transmission for different UEs. Accordingly, there is a definition of PUSCH resource unit (PRU), which is a combination of a specific PUSCH occasion and a DMRS port and/or sequence. Therefore, one PUSCH occasion contains one or multiple PRUs, depending on a BS's configuration.

The preambles transmitted in ROs in a PRACH slot are mapped to the PRUs of the POs in the associated PUSCH slots. The mapping is done by ordering the preambles and ordering the PRUs. Then, the ordered preambles can be one-to-one or multiple-to-one mapped to the PRUs.

From a UE point of view, once the UE transmits a MsgA preamble in a RO of a PRACH slot, the UE can find a PRU from the preamble to PRU mapping. That is, the UE could find a PO and a DMRS port and sequence for MsgA PUSCH transmission. Similarly, for a BS, if the BS detects a preamble from a RO, the BS can find a PRU for receiving the MsgA PUSCH.

FIG. 2 illustrates an exemplary diagram of mapping preambles to PRUs for non-RedCap UEs in accordance with some embodiments of the present disclosure. A PRACH slot may be associated with a set of PUSCH slots. The preambles transmitted in ROs in the PRACH slot are ordered and mapped to the ordered PRUs of POs in the set of PUSCH slots. The total number of PUSCH slots within the set of PUSCH slots may be configured by a BS (e.g., BS 102 as shown and illustrated in FIG. 1). For example, FIG. 2 shows that one PRACH slot is associated with a set of three PUSCH slots, and preambles transmitted in ROs in the PRACH slot are mapped to PRUs of POs in these three PUSCH slots.

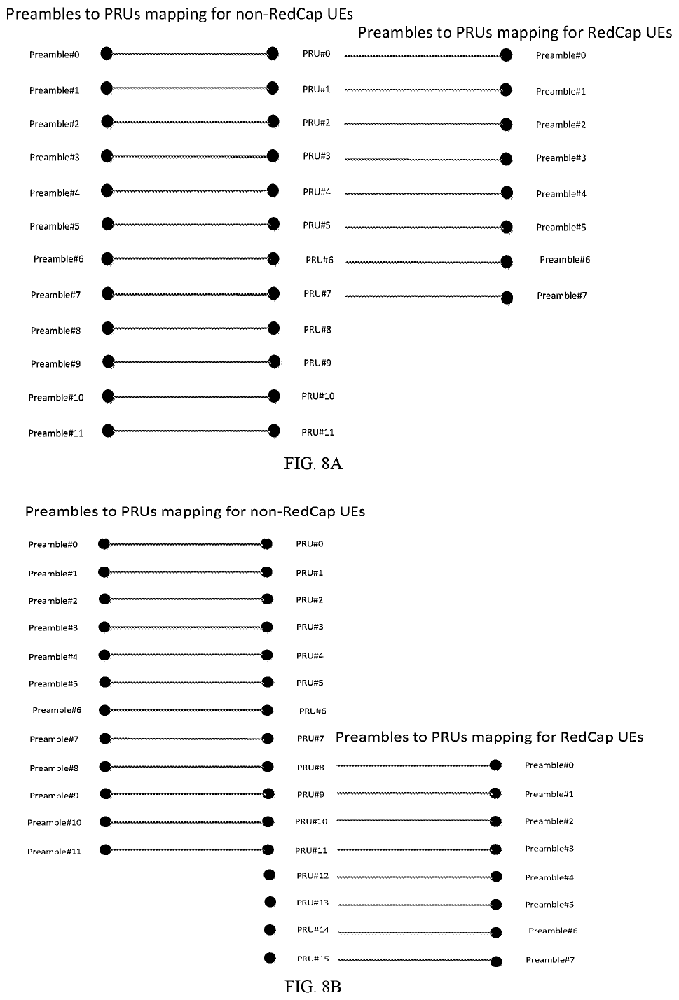

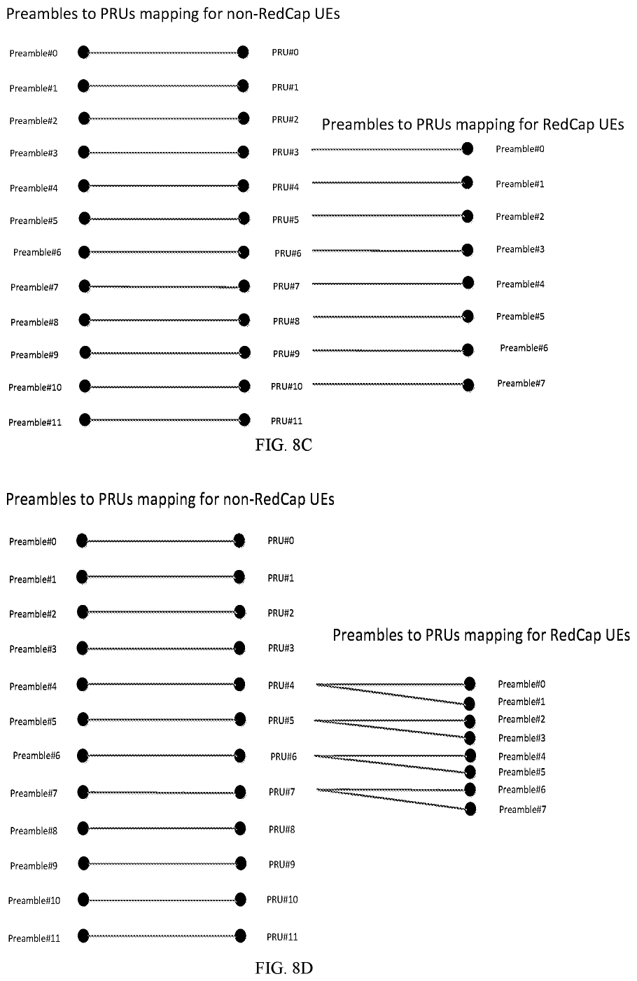

In particular, as shown in FIG. 2, PRACH slot #1 is associated with PUSCH slot #1, PUSCH slot #2, and PUSCH slot #3. A UE (e.g., UE 101 as shown and illustrated in FIG. 1) may transmit a MsgA preamble in a RO of PRACH slot #1, find a PRU in any PUSCH slot associated with PRACH slot #1 based on the preambles to PRUs mapping, and then transmit MsgA data (i.e., MsgA PUSCH) in the PRU. The preambles transmitted in ROs in PRACH slot #1 may be ordered and mapped to the ordered PRUs of POs in PUSCH slot #1, PUSCH slot #2, and PUSCH slot #3. Specific examples are described in embodiments of FIGS. 8A-8D as follows.

A time offset (e.g., T_offset in FIG. 2) may be configured and indicates the time gap between the starting of PRACH slot #1 and the starting of the firstly appeared PUSCH slot in time domain (i.e., PUSCH slot #1) within PUSCH slot #1, PUSCH slot #2, and PUSCH slot #3. For example, T_offset in FIG. 2 is configured as three slots.

In general, for RedCap UEs, a BS might configure dedicated ROs for MsgA preambles, but may not configure MsgA PUSCH resources. In this case, the MsgA PUSCH resources configured for non-RedCap UEs may be reused for RedCap UEs. Based on this, an issue needs to be addressed is that how RedCap UEs determine a resource for MsgA PUSCH transmission in such case. As introduced, for non-RedCap UEs, such determination is based on a configured time offset between a PRACH slot and the associated PUSCH slots. However, for a RedCap UE, it cannot determine the PUSCH resource based this time offset, if separate ROs for RedCap UEs are not configured in a same PRACH slot for non-RedCap UEs.

Embodiments of the present application aim to solve the above-mentioned issue, and propose schemes for RedCap UEs to determine resource(s) for MsgA PUSCH transmission(s). A target scenario is that separate ROs are configured for RedCap UEs while MsgA PUSCH resource(s) are shared with non-RedCap UEs. Basically, a RedCap UE receives dedicated MsgA RACH configurations for 2-step RACH procedure, and receives MsgA PUSCH configurations for 2-step RACH procedure for non-RedCap UEs. Based on these configurations, the RedCap UE may determine PUSCH resource(s) for the MsgA PUSCH transmission(s).

Specifically, in some embodiments of the present application, a PRACH slot for RedCap UEs is associated with a PRACH slot for non-RedCap UEs. Accordingly, a set of PUSCH slots associated with the PRACH slot for non-RedCap UEs are associated with the PRACH slot for RedCap UEs.

In some further embodiments of the present application, a PRACH slot for RedCap UEs is always configured to be with the same indices with the full set or a subset of PRACH slots for non-RedCap UEs. A PRACH slot for RedCap UEs is associated with a PRACH slot for non-RedCap UEs with the same index. In some other embodiments of the present application, a PRACH slot for RedCap UEs is NOT always configured to be with the same indices with at least some of PRACH slots for non-RedCap UEs. In this case, a PRACH slot for RedCap UEs is associated with a following first PRACH slot (i.e., a subsequent PRACH slot firstly appeared in time domain) for non-RedCap UEs.

In some additional embodiments of the present application, a PRACH slot with dedicated ROs for RedCap UEs is associated with a subsequent time domain firstly appeared set of consecutive PUSCH slots, which are associated with a PRACH slot for non-RedCap UEs. In some yet additional embodiments of the present application, a PRACH slot with dedicated ROs for RedCap UEs is associated with a firstly appeared set of PUSCH slots in time domain after a time gap. As an option, the time gap is a configured time offset between the starting of PRACH slot for non-RedCap UEs and the starting of the time domain firstly appeared PUSCH slot of the set of consecutive PUSCH slots. In another embodiment, the time gap is configured by the BS. The configuration for the time gap might be through a broadcasting signaling or a UE specific signaling. In yet another embodiment, the time gap might be predefined and is a fixed value.

In some yet additional embodiments of the present application, preambles transmitted in ROs in a PRACH slot for RedCap UEs are ordered and mapped to PRUs of POs of the associated PUSCH slots. The mapping may start from a specific PRU, which is determined based on a configuration, e.g., a PRU offset “k” is configured by a BS, and the mapping starts from PRU #k for RedCap UEs. The configuration might be through a broadcasting signaling or a UE specific signaling. In some yet additional embodiments of the present application, a BS could further configure a subset of PUSCH slots among those consecutive PUSCH slots determined for RedCap UEs. The PRUs of the POs in such subset of PUSCH slots are mapped with the preambles transmitted in the ROs in the PRACH slot for RedCap UEs.

More details will be illustrated in the following text in combination with the appended drawings. Persons skilled in the art should well know that the wording “a/the first,” “a/the second” and “a/the third” etc. are only used for clear description, and should not be deemed as any substantial limitation, e.g., sequence limitation.

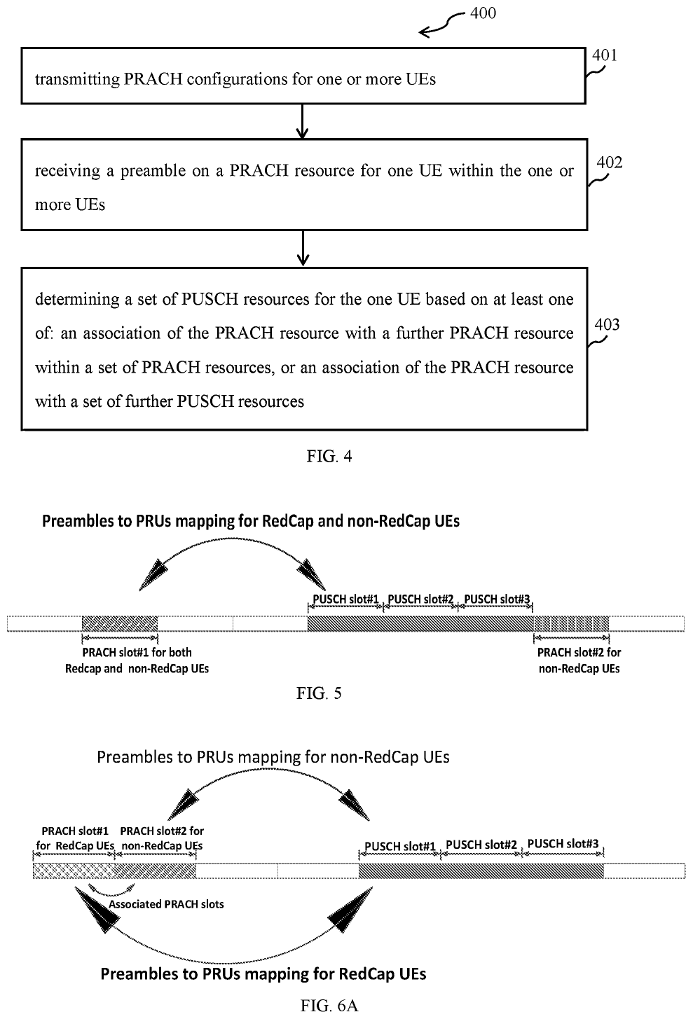

FIG. 3 illustrates an exemplary flowchart of determining a set of PUSCH resources in accordance with some embodiments of the present application. The exemplary method 300 in the embodiments of FIG. 3 may be performed by a UE, e.g., a RedCap UE (e.g., UE 101 as shown and illustrated in FIG. 1). Although described with respect to a UE (e.g., a RedCap UE), it should be understood that other devices may be configured to perform a method similar to that of FIG. 3. Details described in all other embodiments of the present disclosure are applicable for the embodiments shown in FIG. 3. Moreover, details described in the embodiments of FIG. 3 are applicable for all the embodiments of FIGS. 4-11.

In the exemplary method 300 as shown in FIG. 3, in operation 301, a UE receives PRACH configurations (e.g., for RedCap UEs and/or non-RedCap UEs). In operation 302, the UE determines a PRACH resource (which is marked as “the 1st PRACH resource” for simplicity) based on the PRACH configurations. In operation 303, the UE determines a set of PUSCH resources (which is marked as “the set of 1st PUSCH resources” for simplicity) for the UE based on at least one of: an association of the 1st PRACH resource with a further PRACH resource (which is marked as “the 2nd PRACH resource” for simplicity) within a set of PRACH resources, or an association of the 1st PRACH resource with a set of further PUSCH resources (which is marked as “the set of 2nd PUSCH resources” for simplicity).

In some embodiments, at least one resource of the 1st PRACH resource, the set of PRACH resources, the set of 1st PUSCH resources, or the set of 2nd PUSCH resources is a resource associated with at least one of: a time domain, a frequency domain, or a spatial domain.

In some embodiments, at least one of the set of PRACH resources or the set of 2nd PUSCH resources is configured for another type of UE (e.g., a non-RedCap UE). In some embodiments, the UE is a RedCap UE, and another type of UE is a non-RedCap UE. For example, the 1st PRACH resource and the set of 1st PUSCH resources are configured for the RedCap UE. The set of PRACH resources and the set of 2nd PUSCH resources are configured for the non-RedCap UE.

In some embodiments, preambles transmitted in ROs in the 1st PRACH resource are mapped to PRUs within the set of 1st PUSCH resources. In some embodiments, the 1st PRACH resource is a subset of the set of PRACH resources. In some embodiments, the 1st PRACH resource is associated with the 2nd PRACH resource, and the 1st PRACH resource and the 2nd PRACH resource have a same index value in a time domain. A specific example is described in embodiments of FIG. 5 as follows.

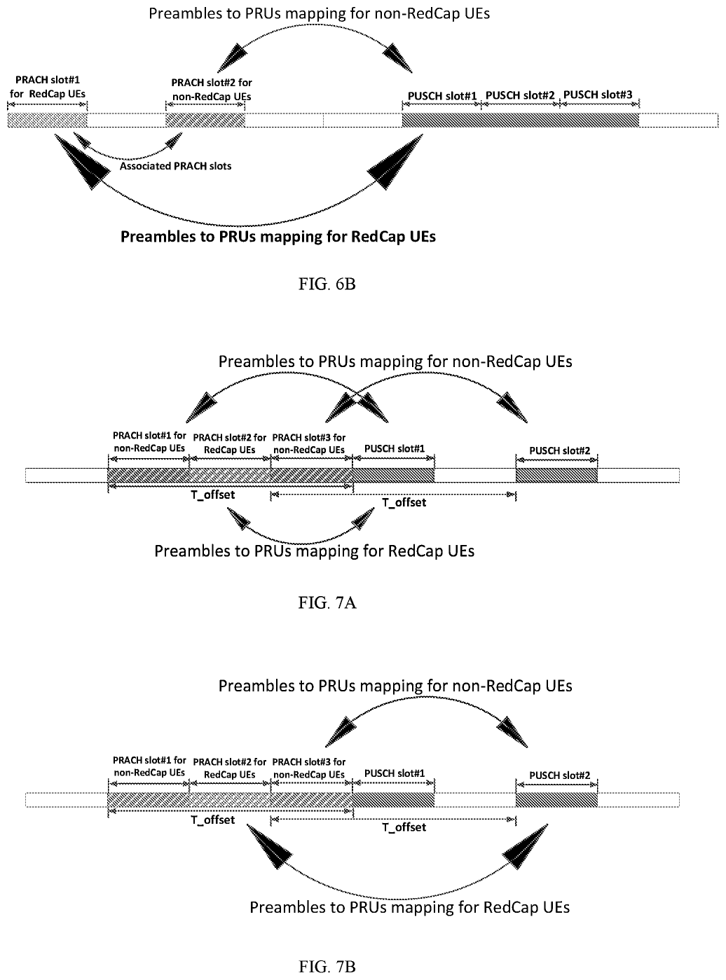

In some embodiments, the 1st PRACH resource is associated with the 2nd PRACH resource. The 2nd PRACH resource is a time domain firstly appeared PRACH resource within the set of PRACH resources which is subsequent to the 1st PRACH resource. In an embodiment, the 1st PRACH resource and the 2nd PRACH resource are adjacent in the time domain. In some embodiments, at least one of the 1st PRACH resource or the 2nd PRACH resource includes one PRACH slot. Specific examples are described in embodiments of FIGS. 6A and 6B as follows.

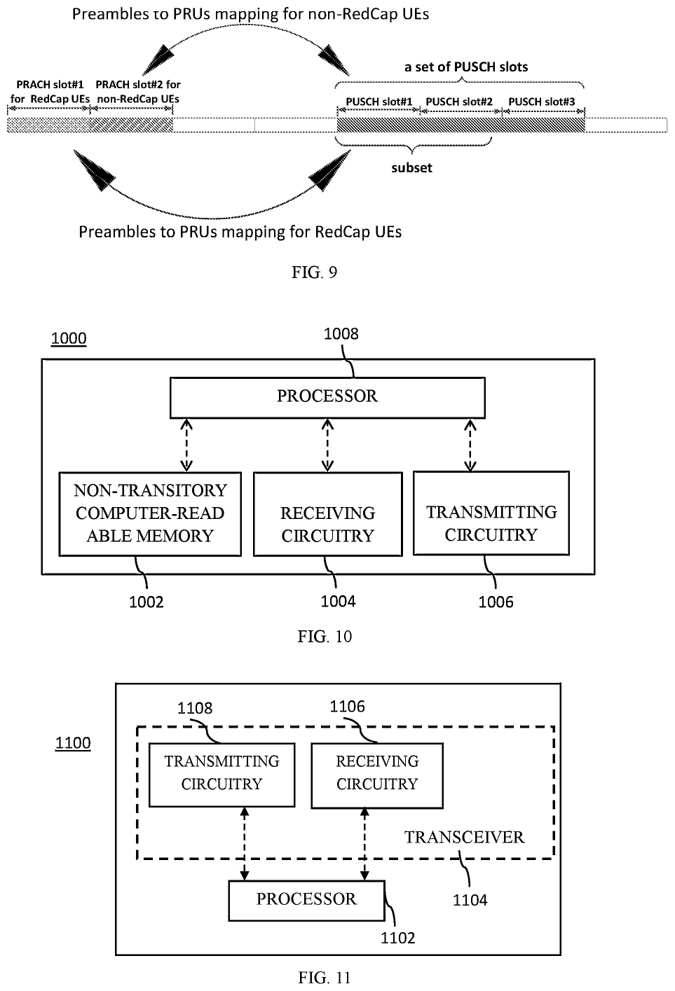

In some embodiments, the set of 1st PUSCH resources is the set of 2nd PUSCH resources. Specific examples are described in embodiments of FIGS. 5-7B as follows. In some other embodiments, the set of 1st PUSCH resources is a subset of the set of 2nd PUSCH resources. In some embodiments, a total number of resources included in the subset of the set of 2nd PUSCH resources is configured by a network node (e.g., BS 102 as shown and illustrated in FIG. 1). The configuration for the total number might be through a broadcasting signaling or a UE specific signaling. A specific example is described in embodiments of FIG. 9 as follows.

In some embodiments, in response to the set of 1st PUSCH resources being the set of 2nd PUSCH resources, the set of 2nd PUSCH resources is a time domain firstly appeared set of PUSCH resources which is subsequent to the 1st PRACH resource. A specific example is described in embodiments of FIG. 7A as follows.

In some embodiments, in response to the set of 1st PUSCH resources being the set of 2nd PUSCH resources, the set of 2nd PUSCH resources is a time domain firstly appeared set of PUSCH resources which is subsequent to the 1st PRACH resource after a time gap. In some embodiments, a starting time instance of the time gap is identical with or later than an ending time instance of the set of 1st PUSCH resources. In some embodiments, the time gap is a time offset configured by the network node for one or more second type of UEs (e.g., non-RedCap UEs). The time offset is between a starting time instance of a PRACH resource and a starting time instance of a time domain firstly appeared PUSCH resource within the set of 2nd PUSCH resources. The time domain firstly appeared PUSCH resource is associated with the PRACH resource. In some other embodiments, the time gap is a time duration configured by the network node. The configuration for the time gap might be through a broadcasting signaling or a UE specific signaling. The time duration starts from a starting time instance or an ending time instance of the 1st PRACH resource. A specific example is described in embodiments of FIG. 7B as follows.

In some embodiments, the method further comprises: ordering preambles transmitted in ROs in the 1st PRACH resource; to order PRUs of PUSCH occasions (POs) in the set of 1st PUSCH resources; and mapping the ordered preambles transmitted in the ROs in the 1st PRACH resource to the ordered PRUs of the POs in the set of 1st PUSCH resources.

In some embodiments, mapping the ordered preambles transmitted in the ROs to the ordered PRUs of the POs further comprises: mapping a preamble with a minimum index value within the ordered preambles transmitted in the ROs to a PRU with a minimum index value within the ordered PRUs of the POs; or mapping the preamble with the minimum index value within the ordered preambles transmitted in the ROs to a PRU with a configured index value or a pre-configured index value within the ordered PRUs of the POs; or mapping a preamble with a maximum index value within the ordered preambles transmitted in the ROs to a PRU with a maximum index value within the ordered PRUs of the POs; or mapping the ordered preambles transmitted in the ROs to a subset of the ordered PRUs of the POs based on a configuration. Specific examples are described in embodiments of FIGS. 8A-8D as follows.

FIG. 4 illustrates a further exemplary flowchart of determining a set of PUSCH resources in accordance with some embodiments of the present application. The exemplary method 400 in the embodiments of FIG. 4 may be performed by a network device, e.g., a BS (e.g., BS 102 as shown and illustrated in FIG. 1). Although described with respect to a network device (e.g., a BS), it should be understood that other devices may be configured to perform a method similar to that of FIG. 4. Details described in all other embodiments of the present disclosure are applicable for the embodiments shown in FIG. 4. Moreover, details described in the embodiments of FIG. 4 are applicable for all the embodiments of FIGS. 3 and 5-11.

In the exemplary method 400 as shown in FIG. 4, in operation 401, a network node (e.g., a BS) transmits PRACH configurations for one or more UEs (e.g., RedCap UEs and/or non-RedCap UEs). In operation 402, the BS receives a preamble on a PRACH resource (which is marked as “the 1st PRACH resource” for simplicity) for one UE (e.g., a RedCap UE) within the one or more UEs. In operation 403, the BS determines a set of PUSCH resources (which is marked as “the set of 1st PUSCH resources” for simplicity) for the one UE based on at least one of: an association of the 1st PRACH resource with a further PRACH resource (which is marked as “the 2nd PRACH resource” for simplicity) within a set of PRACH resources, or an association of the 1st PRACH resource with a set of further PUSCH resources (which is marked as “the set of 2nd PUSCH resources” for simplicity).

In some embodiments, at least one resource of the 1st PRACH resource, the set of PRACH resources, the set of 1st PUSCH resources, or the set of 2nd PUSCH resources is a resource associated with at least one of: a time domain, a frequency domain, or a spatial domain.

In some embodiments, at least one of the set of PRACH resources or the set of 2nd PUSCH resources is configured for another type of UE (e.g., a non-RedCap UE). In some embodiments, the one UE is a RedCap UE, and another type of UE is a non-RedCap UE. For example, the 1st PRACH resource and the set of 1st PUSCH resources are configured for the RedCap UE. The set of PRACH resources and the set of 2nd PUSCH resources are configured for the non-RedCap UE.

In some embodiments, preambles transmitted in ROs in the 1st PRACH resource are mapped to PRUs within the set of 1st PUSCH resources. In some embodiments, the 1st PRACH resource is a subset of the set of PRACH resources. In some embodiments, the 1st PRACH resource is associated with the 2nd PRACH resource, and the 1st PRACH resource and the 2nd PRACH resource have a same index value in a time domain. A specific example is described in embodiments of FIG. 5 as follows.

In some embodiments, the 1st PRACH resource is associated with the 2nd PRACH resource. The 2nd PRACH resource is a time domain firstly appeared PRACH resource within the set of PRACH resources which is subsequent to the 1st PRACH resource. In an embodiment, the 1st PRACH resource and the 2nd PRACH resource are adjacent in the time domain. In some embodiments, at least one of the 1st PRACH resource or the 2nd PRACH resource includes one PRACH slot. Specific examples are described in embodiments of FIGS. 6A and 6B as follows.

In some embodiments, the set of 1st PUSCH resources is the set of 2nd PUSCH resources. Specific examples are described in embodiments of FIGS. 5-7B as follows. In some other embodiments, the set of 1st PUSCH resources is a subset of the set of 2nd PUSCH resources. In some embodiments, a total number of resources included in the subset of the set of 2nd PUSCH resources is configured by the network node (e.g., BS 102 as shown and illustrated in FIG. 1). A specific example is described in embodiments of FIG. 9 as follows.

In some embodiments, in response to the set of 1st PUSCH resources being the set of 2nd PUSCH resources, the set of 2nd PUSCH resources is a time domain firstly appeared set of PUSCH resources which is subsequent to the 1st PRACH resource. A specific example is described in embodiments of FIG. 7A as follows.

In some embodiments, in response to the set of 1st PUSCH resources being the set of 2nd PUSCH resources, the set of 2nd PUSCH resources is a time domain firstly appeared set of PUSCH resources which is subsequent to the 1st PRACH resource after a time gap. In some embodiments, a starting time instance of the time gap is identical with or later than an ending time instance of the set of 1st PUSCH resources. In some embodiments, the time gap is a time offset configured by the network node for one or more second type of UEs (e.g., non-RedCap UEs). The time offset is between a starting time instance of a PRACH resource and a starting time instance of a time domain firstly appeared PUSCH resource within the set of 2nd PUSCH resources. The time domain firstly appeared PUSCH resource is associated with the PRACH resource. In some other embodiments, the time gap is a time duration configured by the network node. The time duration starts from a starting time instance or an ending time instance of the 1st PRACH resource. A specific example is described in embodiments of FIG. 7B as follows.

In some embodiments, the method further comprises: ordering preambles transmitted in ROs in the 1st PRACH resource; to order PRUs of PUSCH occasions (POs) in the set of 1st PUSCH resources; and mapping the ordered preambles transmitted in the ROs in the 1st PRACH resource to the ordered PRUs of the POs in the set of 1st PUSCH resources.

In some embodiments, mapping the ordered preambles transmitted in the ROs to the ordered PRUs of the POs further comprises: mapping a preamble with a minimum index value within the ordered preambles transmitted in the ROs to a PRU with a minimum index value within the ordered PRUs of the POs; or mapping the preamble with the minimum index value within the ordered preambles transmitted in the ROs to a PRU with a configured index value or a pre-configured index value within the ordered PRUs of the POs; or mapping a preamble with a maximum index value within the ordered preambles transmitted in the ROs to a PRU with a maximum index value within the ordered PRUs of the POs; or mapping the ordered preambles transmitted in the ROs to a subset of the ordered PRUs of the POs based on a configuration. Specific examples are described in embodiments of FIGS. 8A-8D as follows.

The following text describes specific embodiments of FIGS. 5-11, wherein PRACH resource(s) and PUSCH resource(s) are shown and illustrated as PRACH slot(s) and PUSCH slot(s), respectively, only for exemplary purposes. It is contemplated that PRACH resource(s) and PUSCH resource(s) in the embodiments of FIGS. 5-11 may be resource(s) associated with a time domain, a frequency domain, and/or a spatial domain, as described in embodiments of FIGS. 3 and 4, without departing from the spirit and scope of the disclosure.

In particular, in embodiments of FIGS. 5, 6A and 6B, a PRACH slot for RedCap UEs is associated with a PRACH slot for non-RedCap UEs. Accordingly, the set of PUSCH slots associated with the PRACH slot for non-RedCap UEs are associated with the PRACH slot for RedCap UEs.

FIG. 5 illustrates an exemplary diagram of mapping preambles to PRUs for RedCap UEs in accordance with some embodiments of the present disclosure. In the embodiments of FIG. 5, PRACH slots for RedCap UEs are always configured to be with the same indices with the full set or a subset of PRACH slots for non-RedCap UEs. A PRACH slot for RedCap UEs is associated with a PRACH slot for non-RedCap UEs with the same slot index.

As shown in FIG. 5, PRACH slots for RedCap UEs are configured as a subset of those for non-RedCap UEs, and a PRACH slot for both RedCap UEs and non-RedCap UEs has the same slot index. Preambles transmitted in ROs for RedCap UEs and ROs for non-RedCap UEs in this PRACH slot are mapped to the same set of PRUS. Specifically, PRACH slot #1 is for both RedCap UEs and non-RedCap UEs, while PRACH slot #2 is only for non-RedCap UEs. That is, PRACH slots for both RedCap UEs and non-RedCap UEs have the same slot index. Thus, preambles transmitted in ROs for RedCap UEs and preambles transmitted in ROs for non-RedCap UEs in PRACH slot #1 are mapped to the same set of PRUs within a set of PUSCH slots, e.g., PUSCH slot #1, PUSCH slot #2, and PUSCH slot #3, as shown in FIG. 5, i.e., preambles to PRUs mapping for RedCap UEs and non-RedCap UEs are the same.

FIGS. 6A and 6B illustrate further exemplary diagrams of mapping preambles to PRUs for RedCap UEs in accordance with some embodiments of the present disclosure. In the embodiments of FIGS. 6A and 6B, PRACH slots for RedCap UEs are NOT always configured to be with the same indices with at least some of PRACH slots for non-RedCap UEs. In this case, a PRACH slot for RedCap UEs is associated with a subsequent PRACH slot firstly appeared in time domain for non-RedCap UEs.

As shown in FIG. 6A, a PRACH slot for RedCap UEs is associated with a neighboring PRACH slot for non-RedCap UEs. PRACH slot #1 for RedCap UEs is adjacent with PRACH slot #2 for non-RedCap UEs. PRACH slot #1 and PRACH slot #2 are associated PRACH slots. For PRACH slot #1, PRACH slot #2 is a subsequent PRACH slot firstly appeared in time domain for non-RedCap UEs.

As shown in FIG. 6B, PRACH slot #1 for RedCap UEs is not adjacent with PRACH slot #2 for non-RedCap UEs, while PRACH slot #1 and PRACH slot #2 are associated PRACH slots. For PRACH slot #1, PRACH slot #2 is a subsequent PRACH slot firstly appeared in time domain for non-RedCap UEs.

According to the embodiments of FIGS. 6A and 6B, the set of PUSCH slots (e.g., PUSCH slot #1, PUSCH slot #2, and PUSCH slot #3) associated with PRACH slot #2 for non-RedCap UEs are associated with PRACH slot #1 for RedCap UEs. That is, preambles transmitted in ROs for RedCap UEs in PRACH slot #1 and preambles transmitted in ROs for non-RedCap UEs in PRACH slot #2 are mapped to the same set of PRUs in the set of PUSCH slots (e.g., PUSCH slot #1, PUSCH slot #2, and PUSCH slot #3).

FIGS. 7A and 7B illustrate additional exemplary diagrams of mapping preambles to PRUs for RedCap UEs in accordance with some embodiments of the present disclosure. In the embodiments of FIGS. 7A and 7B, there is no explicit association defined between PRACH slots for RedCap UEs and PRACH slots for non-RedCap UEs, instead, a PRACH slot for RedCap UEs may be associated with different sets of PUSCH slots in different scenarios.

In particular, FIG. 7A shows mapping of preambles transmitted in ROs in a PRACH slot for RedCap UEs with PRUs of POs in a following first set of PUSCH slots (i.e., a subsequent set of PUSCH slots firstly appeared in time domain) for non-RedCap UEs. According to the embodiments of FIG. 7A, one PRACH slot is associated with a following first set of PUSCH resources, i.e., one PUSCH slot. The PRACH slot for RedCap UEs is associated with a nearest PUSCH slot for non-RedCap UEs.

As shown in FIG. 7A, PRACH slot #1 for non-RedCap UEs is associated with PUSCH slot #1. PRACH slot #3 for non-RedCap UEs is associated with PUSCH slot #2. There is a configured time gap (e.g., T_offset) between the starting of PRACH slot and the starting of the first PUSCH slot of the set of consecutive PUSCH slots. PRACH slot #2 with dedicated ROs for RedCap UEs is associated with a following first set of PUSCH slots, i.e., PUSCH slot #1, which is associated with PRACH slot #3 for non-RedCap UEs.

FIG. 7B shows mapping of preambles transmitted in ROs in a PRACH slot for RedCap UEs with PRUs of POs in a following first set of PUSCH slots for non-RedCap UEs after a time gap. In an embodiment, the time gap is greater than or equal to the configured time offset between the starting of PRACH slot for non-RedCap UEs and the starting of the firstly appeared PUSCH slot of the set of consecutive PUSCH slots (i.e., T_offset). In another embodiment, the time gap is configured by the BS. For example, the time gap is a time duration configured by the BS, which starts from a starting time instance or an ending time instance of the PRACH resource for RedCap UEs.

The embodiments of FIG. 7B refer to the same configurations as those in embodiments of FIG. 7A. For example, as shown in FIG. 7B, one PRACH slot is associated with a set of PUSCH slots, i.e., one PUSCH slot in FIG. 7B. Different from FIG. 7A, in embodiments of FIG. 7B, PRACH slot #2 with dedicated ROs for RedCap UEs is associated with a firstly appeared set of PUSCH slots after a time gap (e.g., which is configured as T_offset as shown in FIG. 7B). As shown in FIG. 7B, PRACH slot #2 for RedCap UEs is associated with a nearest PUSCH slot (e.g., PUSCH slot #2 as shown in FIG. 7B) for non-RedCap UEs with a time gap between a starting time instance of PRACH slot #2 for RedCap UEs and a starting time instance of PUSCH slot #2 being greater than the configured T_offset, e.g., three slots as shown in FIG. 7B. However, since a time gap between the starting time instance of PRACH slot #2 for RedCap UEs and a starting time instance of PUSCH slot #1 is not greater than the configured T_offset, e.g., three slots as shown in FIG. 7B, PRACH slot #2 for RedCap UEs is not associated with PUSCH slot #1. That is, PRUs in PUSCH slot #2 are used for transmitting MsgA PUSCH for RedCap UEs, while PRUs in PUSCH slot #1 are not used for transmitting MsgA PUSCH for RedCap UEs.

FIGS. 8A-8D illustrate exemplary diagrams of mapping preambles to PRUs for RedCap and non-RedCap UEs in accordance with some embodiments of the present disclosure. In embodiments of FIGS. 8A-8D, preambles transmitted in ROs in a PRACH slot for RedCap UEs are ordered and mapped to PRUs of POs of the associated PUSCH slots. FIGS. 8A-8D show mapping of preambles to PRUs starting from a specific PRU.

In particular, FIG. 8A shows that mapping of preambles to PRUs for RedCap UEs starts from the firstly indexed PRU (i.e., PRU index 0) of the ordered PRUs. As shown in FIG. 8A, a set of PUSCH slots include 11 ordered PRUs (i.e., PRU #0 to PRU #11) in total. For non-RedCap UEs, the ordered preambles (i.e., preamble #0 to preamble #11) are one-to-one mapped to the ordered PRU #0 to PRU #11. For RedCap UEs, the ordered preambles (i.e., preamble #0 to preamble #7) are one-to-one mapped to the ordered PRU #0 to PRU #7 starting from PRU index 0. That is, non-RedCap UEs and RedCap UEs share a subset of PRUs, i.e., PRU #0 to PRU #7, in the embodiments of FIG. 8A.

FIG. 8B shows that mapping of preambles to PRUs for RedCap UEs ends in the lastly indexed PRU of the ordered PRUs. As shown in FIG. 8B, a set of PUSCH slots include 15 ordered PRUs (i.e., PRU #0 to PRU #15) in total. For non-RedCap UEs, the ordered preambles (i.e., preamble #0 to preamble #11) are one-to-one mapped to the ordered PRU #0 to PRU #11. For RedCap UEs, the ordered preambles (i.e., preamble #0 to preamble #7) are one-to-one mapped to the ordered PRU #8 to PRU #15 ending at PRU index 15. That is, non-RedCap UEs and RedCap UEs share a subset of PRUs, i.e., PRU #8 to PRU #15, in the embodiments of FIG. 8B.

FIGS. 8C and 8D shows that mapping of preambles to PRUs for RedCap UEs starts from a specific PRU (i.e., a PRU with a specific index value or an offset value), which may be determined based on a configuration, e.g., a PRU index “k” is configured by a BS, and the mapping starts from PRU #k for RedCap UEs.

As shown in FIG. 8C, a set of PUSCH slots include 11 ordered PRUs (i.e., PRU #0 to PRU #11) in total. For non-RedCap UEs, the ordered preambles (i.e., preamble #0 to preamble #11) are one-to-one mapped to the ordered PRU #0 to PRU #11. For RedCap UEs, the ordered preambles (i.e., preamble #0 to preamble #7) are one-to-one mapped to the ordered PRU #3 to PRU #10 starting from PRU #3. That is, non-RedCap UEs and RedCap UEs share a subset of PRUs, i.e., PRU #3 to PRU #10, in the embodiments of FIG. 8C.

As shown in FIG. 8D, a set of PUSCH slots include 11 ordered PRUs (i.e., PRU #0 to PRU #11) in total. For non-RedCap UEs, the ordered preambles (i.e., preamble #0 to preamble #11) are one-to-one mapped to the ordered PRU #0 to PRU #11. For RedCap UEs, the ordered preambles (i.e., preamble #0 to preamble #7) are two-to-one mapped to the ordered PRU #4 to PRU #7 starting from PRU #4. As one embodiment, the set of PRUs (e.g., including the starting PRU, PRU #4 and the number of PRUs, i.e., 4PRUs) are configured by the BS for mapping. That is, non-RedCap UEs and RedCap UEs share a subset of PRUs, i.e., PRU #4 to PRU #7, in the embodiments of FIG. 8D.

FIG. 9 illustrates an exemplary diagram of mapping preambles to PRUs for RedCap and non-RedCap UEs in accordance with some embodiments of the present disclosure. In embodiments of FIG. 9, a network device, e.g., a BS (e.g., BS 102 as shown and illustrated in FIG. 1), could configure a subset of PUSCH slots among those consecutive PUSCH slots determined for RedCap UEs. PRUs of POs in such subset of PUSCH slots are mapped with preambles transmitted in ROs in the PRACH slot for RedCap UEs. The subset of PUSCH slots may be determined based on the BS's configuration. The BS's configuration might be through a broadcasting signaling or a UE specific signaling.

FIG. 9 shows mapping of preamble to PRUs of POs in a subset of a set of PUSCH slots. As shown in FIG. 9, a set of PUSCH slots including PUSCH slot #1, PUSCH slot #2, and PUSCH slot #3 are associated with PRACH slot #2 for non-RedCap UEs, while a subset of this set of PUSCH slots is associated with PRACH slot #1 for RedCap UEs. PRACH slot #1 for RedCap UEs is mapped to the first two PUSCH slots (i.e., PUSCH slot #1 and PUSCH slot #2) of the determined set of PUSCH slots associated with PRACH slot #2 for non-RedCap UEs. That is, preambles transmitted in ROs for RedCap UEs in PRACH slot #1 are mapped to the subset of PRUs including PUSCH slot #1 and PUSCH slot #2 within the set of PUSCH slots including PUSCH slot #1, PUSCH slot #2, and PUSCH slot #3.

Some embodiments of the present application also provide a wireless communication apparatus for mapping preambles to PRUs for a RedCap UE. For example, FIG. 10 illustrates an exemplary block diagram of an apparatus for mapping preambles to PRUs for a RedCap UE in accordance with some embodiments of the present application.

As shown in FIG. 10, the apparatus 1000 may include at least one non-transitory computer-readable medium 1002, at least one receiving circuitry 1004, at least one transmitting circuitry 1006, and at least one processor 1008 coupled to the non-transitory computer-readable medium 1002, the receiving circuitry 1004 and the transmitting circuitry 1006. The at least one processor 1008 may be a CPU, a DSP, a microprocessor etc. The apparatus 1000 may be a network apparatus (e.g., a BS) or a UE (e.g., a RedCap UE) configured to perform a method illustrated in the above or the like.

Although in this figure, elements such as the at least one processor 1008, receiving circuitry 1004, and transmitting circuitry 1006 are described in the singular, the plural is contemplated unless a limitation to the singular is explicitly stated. In some embodiments of the present application, the receiving circuitry 1004 and the transmitting circuitry 1006 can be combined into a single device, such as a transceiver. In certain embodiments of the present application, the apparatus 1000 may further include an input device, a memory, and/or other components.

In some embodiments of the present application, the non-transitory computer-readable medium 1002 may have stored thereon computer-executable instructions to cause a processor to implement the methods with respect to a RedCap UE or a network apparatus (e.g., a BS) as described or illustrated above in any of FIGS. 3 and 5-9. For example, the computer-executable instructions, when executed, cause the processor 1008 interacting with receiving circuitry 1004 and transmitting circuitry 1006, so as to perform the steps with respect to a RedCap UE or a network apparatus (e.g., a BS) as described or illustrated above in any of FIGS. 4-9.

FIG. 11 illustrates a further exemplary block diagram of an apparatus for mapping preambles to PRUs for a RedCap UE in accordance with some embodiments of the present application.

Referring to FIG. 11, the apparatus 1100, for example a BS or a RedCap UE, may include at least one processor 1102 and at least one transceiver 1104 coupled to the at least one processor 1102. The transceiver 1104 may include at least one separate receiving circuitry 1106 and transmitting circuitry 1108, or at least one integrated receiving circuitry 1106 and transmitting circuitry 1108. The at least one processor 1102 may be a CPU, a DSP, a microprocessor etc.

According to some other embodiments of the present application, when the apparatus 1100 is a UE, the processor 1102 may be configured: to receive physical random access channel (PRACH) configurations via the transceiver 1104; to determine a PRACH resource based on the PRACH configurations; and to determine a set of PUSCH resources for the UE based on at least one of: an association of the PRACH resource with a further PRACH resource within a set of PRACH resources, or an association of the PRACH resource with a set of further PUSCH resources.

According to some embodiments of the present application, when the apparatus 1100 is a BS, the processor 1102 is configured: to transmit physical random access channel (PRACH) configurations for one or more user equipments (UEs) via the transceiver 1104; to receive a preamble on a PRACH resource for one UE within the one or more UEs via the transceiver 1104; and to determine a set of PUSCH resources for the one UE based on at least one of: an association of the PRACH resource with a further PRACH resource within a set of PRACH resources, or an association of the PRACH resource with a set of further PUSCH resources.

The method(s) of the present disclosure can be implemented on a programmed processor. However, controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device that has a finite state machine capable of implementing the flowcharts shown in the figures may be used to implement the processing functions of the present disclosure.

While this disclosure has been described with specific embodiments thereof, it is evident that many alternatives, modifications, and variations may be apparent to those skilled in the art. For example, various components of the embodiments may be interchanged, added, or substituted in the other embodiments. Also, all of the elements of each figure are not necessary for operation of the disclosed embodiments. For example, those having ordinary skills in the art would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The term “having” and the like, as used herein, are defined as “including”.

What is claimed is:

1. A first user equipment (UE) for wireless communication, comprising:
at least one memory; and
at least one processor coupled with the at least one memory and configured to cause the first UE to:
receive one or more physical random access channel (PRACH) configurations;
determine a first PRACH resource based at least in part on the one or more PRACH configurations; and
determine one or more first physical uplink shared channel (PUSCH) resources for the first UE based at least in part on at least one of: an association of the first PRACH resource with a second PRACH resource within one or more PRACH resources, or an association of the first PRACH resource with a set of one or more second PUSCH resources.

2. The first UE of claim 1, wherein at least one of the one or more PRACH resources or the one or more second PUSCH resources is configured for one or more second of UEs.

3. The first UE of claim 2, wherein the first UE comprises a reduced capability (RedCap) UE, and the one or more second UEs comprise non-RedCap UEs.

4. The first UE of claim 1, wherein the first PRACH resource is associated with the second PRACH resource, and wherein the first PRACH resource and the second PRACH resource have a same index value in a time domain.

5. The first UE of claim 1, wherein the first PRACH resource is associated with the second PRACH resource, and wherein the second PRACH resource is a time domain firstly appeared PRACH resource within the one or more PRACH resources which is subsequent to the first PRACH resource.

6. The first UE of claim 1, wherein preambles transmitted in random access channel occasions (ROs) in the first PRACH resource are mapped to PUSCH resource units (PRUs) within the one or more first PUSCH resources.

7. The first UE of claim 1, wherein at least one resource of the first PRACH resource, the one or more PRACH resources, the one or more first PUSCH resources, or the one or more second PUSCH resources comprises a resource associated with at least one of: a time domain, a frequency domain, or a spatial domain.

8. The first UE of claim 1, wherein:
the one or more first PUSCH resources comprises the one or more second PUSCH resources; or
the one or more first PUSCH resources comprises a subset of the one or more second PUSCH resources.

9. The first UE of claim 8, wherein a total number of resources included in the subset of the one or more second PUSCH resources is configured by a network node.

10. The first UE of claim 8, wherein, in response to the one or more first PUSCH resources being the one or more second PUSCH resources, the one or more second PUSCH resources comprises a time domain firstly appeared set of PUSCH resources which is subsequent to the first PRACH resource.

11. The first UE of claim 8, wherein, in response to the one or more first PUSCH resources being the one or more second PUSCH resources, the one or more second PUSCH resources is a time domain firstly appeared one or more PUSCH resources which is subsequent to the first PRACH resource after a time gap.

12. The first UE of claim 11, wherein the time gap comprises at least one of:
a time offset configured by a network node for one or more second UEs, wherein the time offset is between a starting time instance of a PRACH resource of the one or more PRACH resources and a starting time instance of a time domain firstly appeared PUSCH resource within the one or more second PUSCH resources, wherein the time domain firstly appeared PUSCH resource is associated with the PRACH resource; or,
a time duration configured by the network node, wherein the time duration starts from a starting time instance or an ending time instance of the first PRACH resource.

13. The first UE of claim 1, wherein the at least one processor is configured to cause the first UE to:
order preambles transmitted in random access channel occasions (ROs) in the first PRACH resource;
order PUSCH resource units (PRUs) of PUSCH occasions (POs) in the one or more first PUSCH resources; and
map the ordered preambles transmitted in the ROs in the first PRACH resource to the ordered PRUs of the POs in the one or more first PUSCH resources.

14. The first UE of claim 13, wherein, to map the ordered preambles transmitted in the ROs to the ordered PRUs of the POs, the at least one processor is configured to cause the first UE to one or more of:
map a preamble with a minimum index value within the ordered preambles transmitted in the ROs to a PRU with a minimum index value within the ordered PRUs of the POs;
map the preamble with the minimum index value within the ordered preambles transmitted in the ROs to a PRU with a configured index value or a pre-configured index value within the ordered PRUs of the POs;
map a preamble with a maximum index value within the ordered preambles transmitted in the ROs to a PRU with a maximum index value within the ordered PRUs of the POs; or
map the ordered preambles transmitted in the ROs to a subset of the ordered PRUs of the POs based on a configuration.

15. A network node for wireless communication, comprising:
at least one memory; and
at least one processor coupled with the at least one memory and configured to cause the network node to:
transmit one or more physical random access channel (PRACH) configurations for one or more first user equipment (UE);
receive a preamble on a first PRACH resource for a UE of the one or more first UE; and
determine a one or more first PUSCH resources for the UE based on at least one of: an association of the first PRACH resource with a second PRACH resource within a one or more PRACH resources, or an association of the first PRACH resource with one or more second physical uplink shared channel (PUSCH) resources.

16. A processor for wireless communication, comprising:
at least one controller coupled with at least one memory and configured to cause the processor to:
receive, at a first user equipment (UE), one or more physical random access channel (PRACH) configurations;
determine a first PRACH resource based at least in part on the one or more PRACH configurations; and
determine one or more first physical uplink shared channel (PUSCH) resources for the first UE based at least in part on at least one of: an association of the first PRACH resource with a second PRACH resource within one or more PRACH resources, or an association of the first PRACH resource with one or more second PUSCH resources.

17. The processor of claim 16, wherein at least one of the one or more PRACH resources or the one or more second PUSCH resources is configured for one or more second UEs.

18. The processor of claim 17, wherein the first UE comprises a reduced capability (RedCap) UE, and the one or more second UEs comprise non-RedCap UEs.

19. The processor of claim 16, wherein the first PRACH resource is associated with the second PRACH resource, and wherein the first PRACH resource and the second PRACH resource have a same index value in a time domain.

20. A method performed by a user equipment (UE), the method comprising:
receiving, at a first user equipment (UE), one or more physical random access channel (PRACH) configurations;
determining a first PRACH resource based at least in part on the one or more PRACH configurations; and
determining one or more first physical uplink shared channel (PUSCH) resources for the first UE based at least in part on at least one of: an association of the first PRACH resource with a second PRACH resource within one or more PRACH resources, or an association of the first PRACH resource with one or more second PUSCH resources.
